(19) United States
(12) Patent Application Publication
(10) Pub. No.: US 2012/0127419 A1
(43) Pub. Date: May 24, 2012

(54) Novelty Shades

(75) Inventors: Jay Moore, Le Claire, IA (US); Brad Akers, Chicago, IL (US)

(73) Assignee: Tip-Top Branding, LLC, Chicago, IL (US)

(21) Appl. No.: 12/954,315

(22) Filed: Nov. 24, 2010

(51) Int. Cl. G02C 11/02

(52) U.S. Cl. 351/52; 351/51

(57) ABSTRACT

Attractive eyeglasses and novelty shades are provided that are fun and entertaining and can be worn at sporting events, pep rallies, amusement parks, popular concerts, car races, parties, with costumes, and at other places. The improved eyeglasses and novelty shades can comprise an eye glass assembly with at least one appendage connected to the frame and a novelty item connected to the appendage. The novelty item can comprise imitation parts of an animal, mammal, human being, bird, fish, insect, avatar, or cartoon character. At least part of the novelty items can extend outwardly and upwardly from the appendages when the eyeglasses are being worn by the user. The eye glass assembly can also have a logo.

### BACKGROUND OF THE INVENTION

This invention relates to eyeglasses, and more particularly, to novelty eyeglasses.

Over the years various designer eyeglasses, fashion eyewear, sunglasses and novelty shades have been marketed, advertised and manufactured. Many prior designer eyeglasses, fashion eyewear, sunglasses and novelty shades have been popular, entertaining and fun. Some designer eyeglasses, fashion eyewear, sunglasses and novelty shades have been useful with costumes, such as at Halloween. Such designer eyeglasses, fashion eyewear, sunglasses and novelty shades have met with varying degrees of success. Many prior designer eyeglasses, fashion eyewear, sunglasses and novelty shades are expensive, flimsy, readily break, and/or difficult to manufacture.

It is, therefore, desirable to provide an improved eyeglasses and novelty shades, which overcomes most, if not all of the preceding problems.

### BRIEF SUMMARY OF THE INVENTION

Improved eyeglasses and novelty shades are provided that are fashionable, entertaining and fun. The improved eyeglasses and novelty shades can be worn at sporting events, pep rallies, amusement parks, popular concerts, car races, parties, and with costumes, such as at Halloween or Marti Gras. Advantageously, the improved eyeglasses are comfortable safe, portable, light weight, and easily transportable. Desirably, the improved eyeglasses and novelty shades are economical, attractive and fun. Furthermore, the user friendly eyeglasses and novelty shades are simple to use, easy to manufacture, and effective.

The improved eyeglasses can comprise an eye glass assembly with a frame, at least one appendage connected to the frame and a novelty connected to the appendage. Preferably, the frame is of a size and shape so that the eyeglasses can be worn by a child or adult. The eyeglasses can have a logo or other image on the eyeglass assembly. The eyeglasses can comprise one or more of the following: sunglasses, novelty sunglasses, fanciful shades, three dimensional (3D) glasses, eyewear, fashion eyeglasses, designer sunglasses, or specialty eyeglasses.

At least part of the novelty (novelty item) can be positioned at an elevation above an ear of the person when the person is wearing the eyeglasses. In one form, the appendage comprises an upward appendage for extending upwardly from the frame when the person is wearing the eyeglasses. The appendage can have a base portion connected to the frame and an outer portion connected to the base portion for engaging and supporting the novelty.

The novelty can comprise: a novelty item, appendage-engaging member, accessory, decoration, adornment, ornament, attachment, or combinations thereof. The novelty can have a pocket or tube for receiving and engaging the appendage.

In the preferred form, the eyeglasses comprise an eyeglass assembly including: lenses; a frame holding the lenses and having temples with ear pieces that fit upon the ears of a user when the eyeglasses are being worn by the user; upward appendages connected to and extending upwardly from the temples; and novelty items connected to the appendages. The novelty item can comprise imitation parts of an animal, mammal, human being, bird, fish, insect, avatar, or cartoon character. At least part of the novelty item can extend outwardly and upwardly from the appendages when the eyeglasses are being worn by the user. The eyeglass assembly can have a logo or other image.

The novelty items can comprise interchangeable novelty items and can be spaced above the temples. The imitation parts can comprise: ears, antlers, horns, fins, tails, heads, hands, feet, talon, claws, or wings.

A more detailed explanation of the invention is provided in the following detailed descriptions and appended claims taken in conjunction with the accompanying drawings.

### BRIEF DESCRIPTION OF THE DRAWINGS

FIG. 1 is a front view of improved eyeglasses and novelty shades with novelty items comprising animal ears in accordance with principles of the present invention.

FIG. 2 is a partial side perspective view of improved eyeglasses and novelty shades with novelty items comprising animal ears in accordance with principles of the present invention.

FIG. 3 is a front view of improved eyeglasses and novelty shades with a supplemental novelty item (supplemental part) comprising a bird beak in accordance with principles of the present invention.

FIG. 4 is front view of improved eyeglasses and novelty shades with novelty items comprising bear ears on a person (user or wearer) in accordance with principles of the present invention.

FIG. 5 is side perspective view of improved eyeglasses and novelty shades with novelty items comprising bird wings in accordance with principles of the present invention.

FIG. 6 is left side perspective view of improved eyeglasses and novelty shades with novelty items comprising bear ears in accordance with principles of the present invention.

FIG. 7 is right side perspective view of improved eyeglasses and novelty shades with novelty items comprising mouse ears and a supplemental novelty item (supplemental part) comprising a bowtie connecting the mouse ears in accordance with principles of the present invention.

FIG. 8 is front view of improved eyeglasses and novelty shades with novelty items comprising tiger ears in accordance with principles of the present invention.

FIG. 9 is left side perspective view of other improved eyeglasses and novelty shades with novelty items or supplemental parts comprising sideburns in accordance with principles of the present invention.

FIG. 10 is a cross-sectional view of a novelty item comprising a plush ear with a tube or hole to receive an appendage of improved eyeglasses and novelty shades in accordance with principles of the present invention.

FIG. 11 is front view of improved eyeglasses and novelty shades with novelty items comprising faux fur ears or plush ears in accordance with principles of the present invention.

FIG. 12 is an enlarged view of parts of the appendages and temples with ear pieces of improved eyeglasses and novelty shades in accordance with principles of the present invention.

FIG. 13 is a reduced front view of improved eyeglasses and novelty shades with novelty items comprising monkey ears in accordance with principles of the present invention.

FIG. 14 is a reduced front view of improved eyeglasses and novelty shades with novelty items comprising gorilla ears in accordance with principles of the present invention.

FIG. 15 is a reduced front view of improved eyeglasses and novelty shades with novelty items comprising giraffe ears in accordance with principles of the present invention.

FIG. 16 is a reduced front view of improved eyeglasses and novelty shades with novelty items comprising lion ears in accordance with principles of the present invention.

FIG. 17 is a reduced front view of improved eyeglasses and novelty shades with novelty items comprising tiger ears in accordance with principles of the present invention.

FIG. 18 is a reduced front view of improved eyeglasses and novelty shades with novelty items comprising bear, cub or panda ears in accordance with principles of the present invention.

FIG. 19 is a reduced front view of improved eyeglasses and novelty shades with novelty items comprising wolf ears in accordance with principles of the present invention.

FIG. 20 is a reduced front view of improved eyeglasses and novelty shades with novelty items comprising dog ears in accordance with principles of the present invention.

FIG. 21 is a reduced front view of improved eyeglasses and novelty shades with novelty items comprising cat ears in accordance with principles of the present invention.

FIG. 22 is a reduced front view of improved eyeglasses and novelty shades with novelty items comprising elephant ears in accordance with principles of the present invention.

FIG. 23 is a reduced front view of improved eyeglasses and novelty shades with novelty items comprising hippopotamus ears in accordance with principles of the present invention.

FIG. 24 is a reduced front view of improved eyeglasses and novelty shades with novelty items comprising panther ears in accordance with principles of the present invention.

FIG. 25 is a reduced front view of improved eyeglasses and novelty shades with novelty items comprising alligator or crocodile heads in accordance with principles of the present invention.

FIG. 26 is a reduced front view of improved eyeglasses and novelty shades with novelty items comprising buck ears in accordance with principles of the present invention.

FIG. 27 is a reduced front view of improved eyeglasses and novelty shades with novelty items comprising bull ears in accordance with principles of the present invention.

FIG. 28 is a reduced front view of improved eyeglasses and novelty shades with novelty items comprising moose ears in accordance with principles of the present invention.

FIG. 29 is a reduced front view of improved eyeglasses and novelty shades with novelty items comprising horse ears in accordance with principles of the present invention.

FIG. 30 is a reduced front view of improved eyeglasses and novelty shades with novelty items comprising rabbit or bunny ears in accordance with principles of the present invention.

FIG. 31 is a reduced front view of improved eyeglasses and novelty shades with novelty items comprising cow ears in accordance with principles of the present invention.

FIG. 32 is a reduced front view of other improved eyeglasses and novelty shades with novelty items comprising mouse ears in accordance with principles of the present invention.

FIG. 33 is a reduced front view of improved eyeglasses and novelty shades with novelty items comprising kangaroo ears in accordance with principles of the present invention.

FIG. 34 is a front perspective view of improved eyeglasses and novelty shades with novelty items comprising antlers of a buck in accordance with principles of the present invention.

FIG. 35 is a front perspective view of improved eyeglasses and novelty shades with novelty items comprising bird wings of a cardinal and a supplemental novelty item (supplemental part) comprising a bird beak of a cardinal in accordance with principles of the present invention.

FIG. 36 is a side perspective view of the improved eyeglasses and novelty shades of FIG. 35 with novelty items comprising bird wings of a cardinal and a supplemental novelty item (supplemental part) comprising a bird beak of a cardinal in accordance with principles of the present invention.

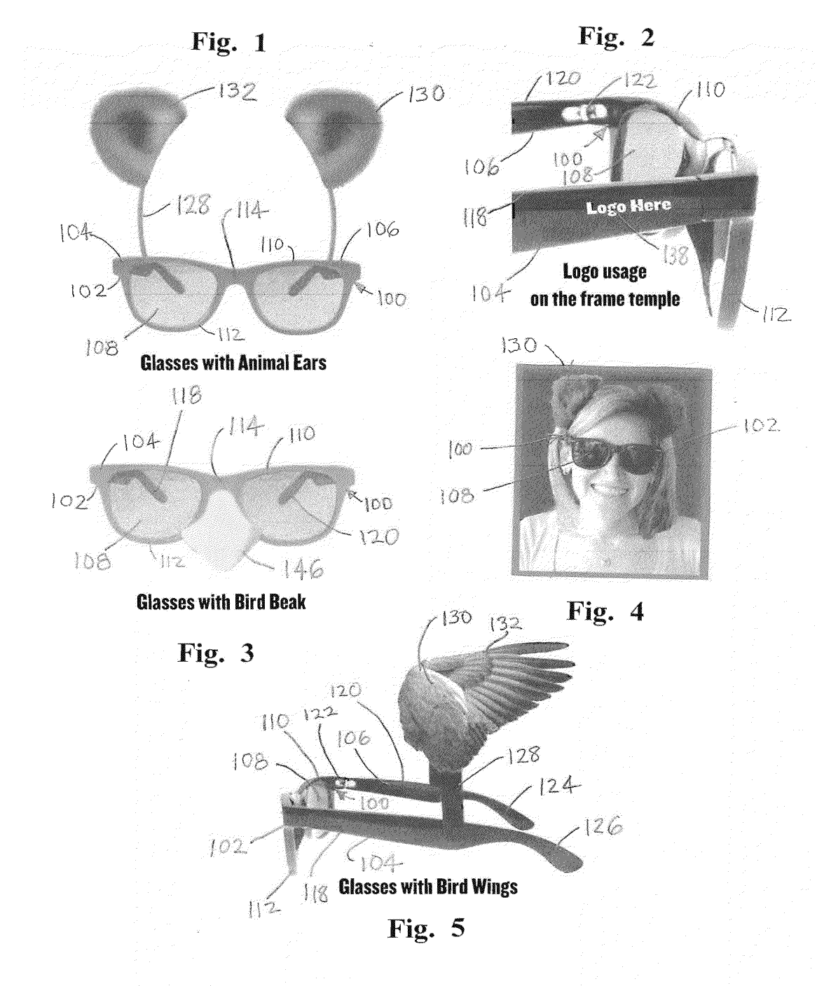

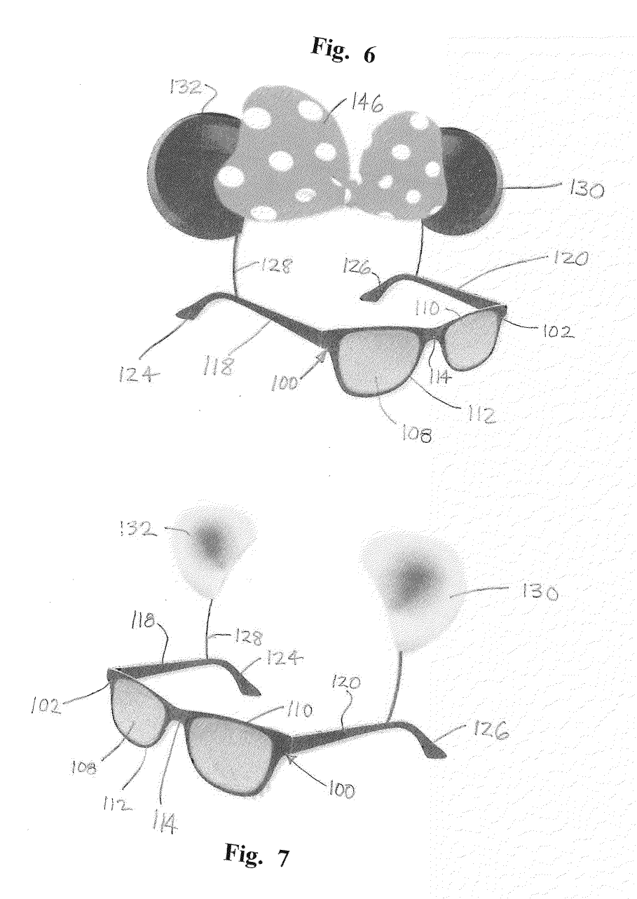

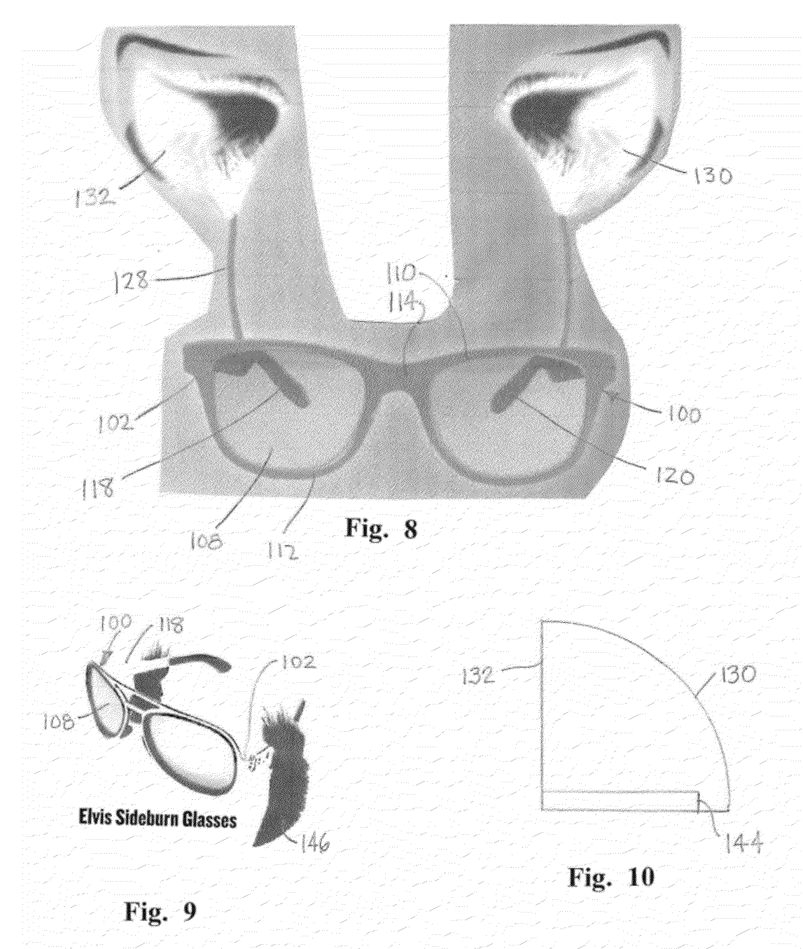

### DETAILED DESCRIPTION OF THE INVENTION

The following is a detailed description and explanation of the preferred embodiments of the invention and best modes for practicing the invention.

As shown in the drawings, eyeglasses 100 can be provided that comprises: novelty sunglasses, fanciful shades, novelty shades, three dimensional (3D) glasses, eyewear, fashion eyeglasses, designer sunglasses, and/or specialty eyeglasses. The eyeglasses can have an eyeglass assembly 102 with an inside 104 comprising inwardly facing surfaces and an outside 106 comprising outwardly facing surfaces. The eyeglass assembly can include a pair of lenses 108 for positioning in front of a person's eyes and an eyeglass frame 110 having a rim 112 for holding and securing the lenses

A bridge 114 can extend between and connect the rim. Nose pads 116 can be connected to the rims for resting upon and positioning the frame on the person's nose. A pair of elongated temples 118 and 120 can be pivotally hinged by a hinge 122 (FIGS. 2 and 5) and connected to the rim. The temples can have earpieces 124 and 126 that fit upon the person's ears. The temples can be moveable from a collapsed storage position against the inward facing surfaces of the rims to an open expanded position when the person is wearing the eyeglasses;

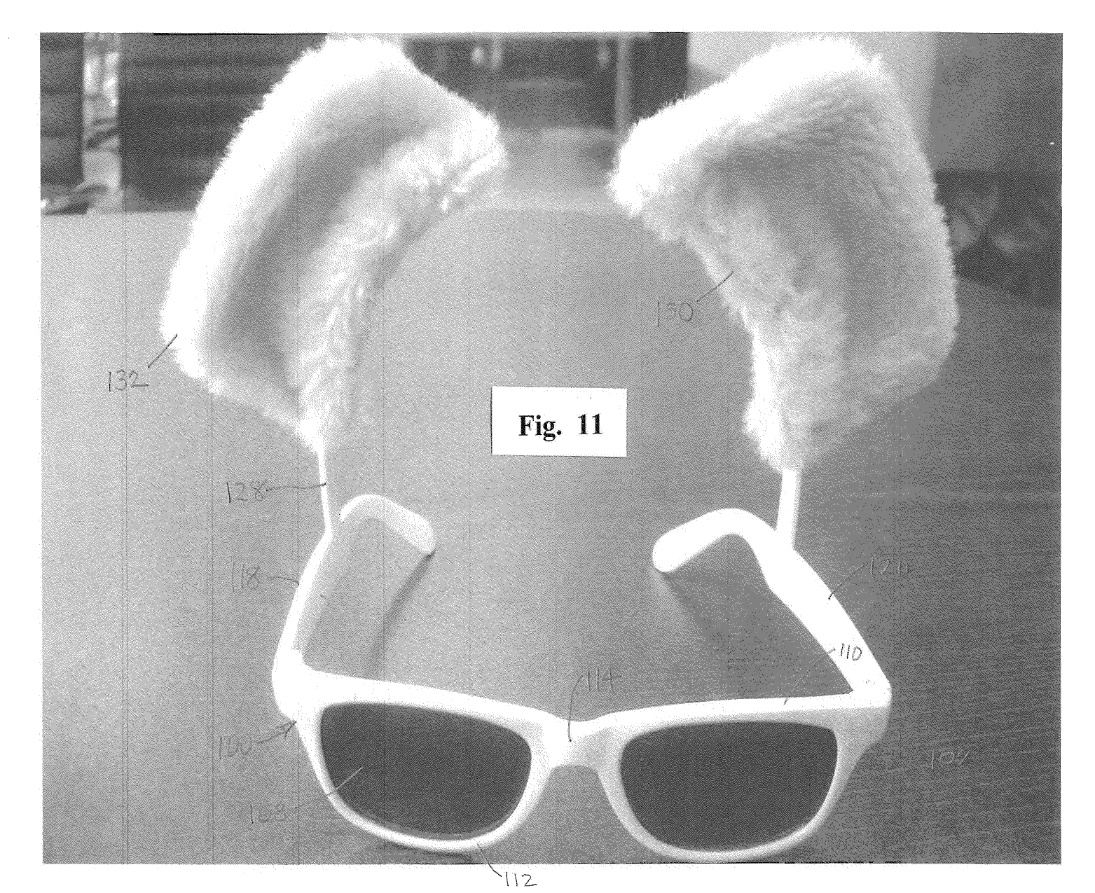

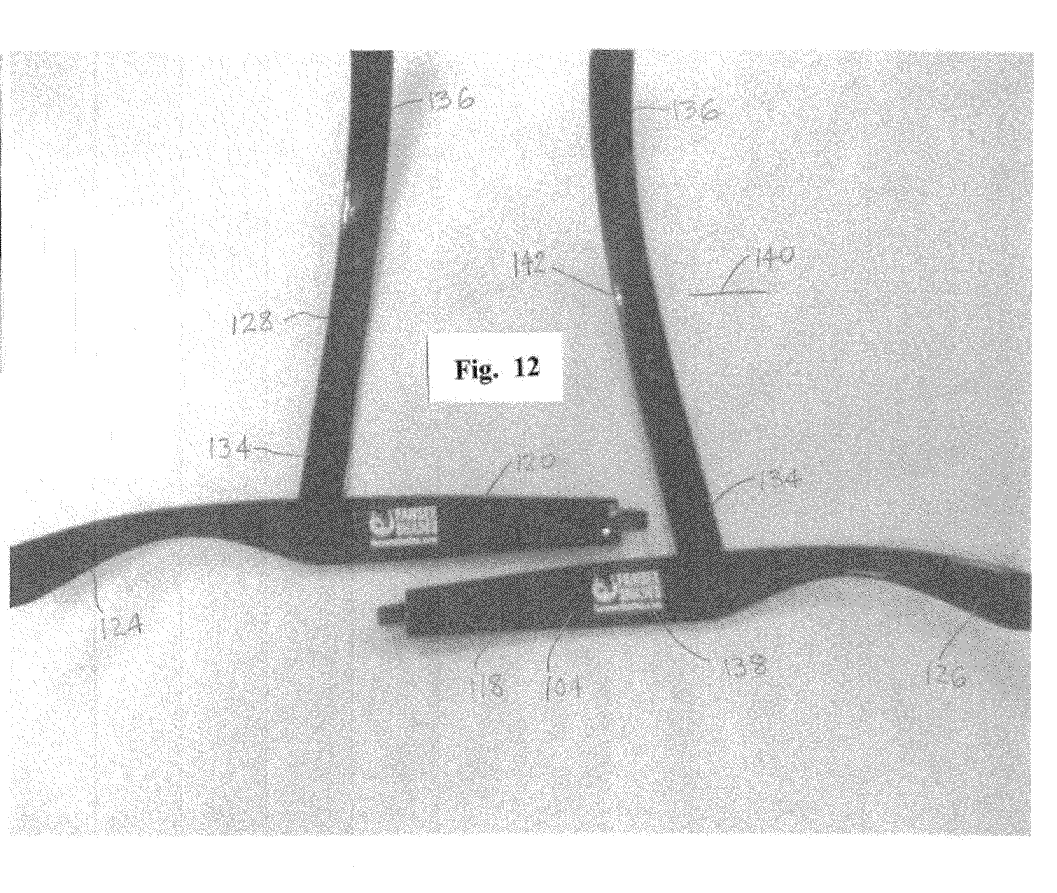

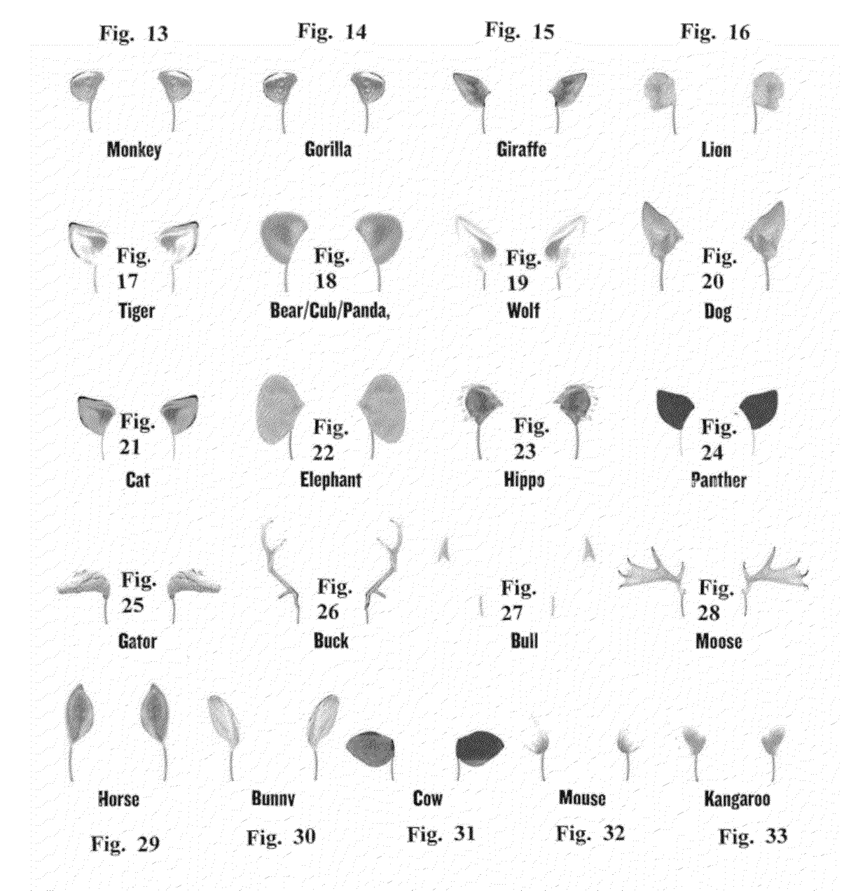

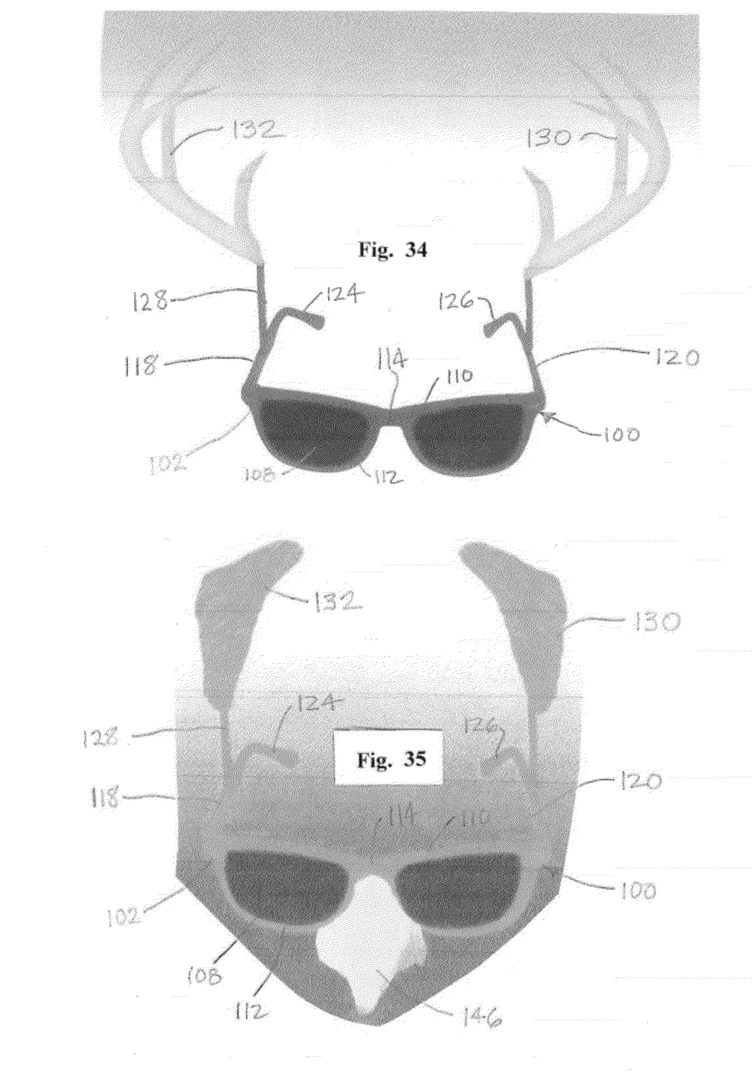

The attractive eyeglasses can have a pair of substantially symmetrical upward appendages 128 that are securely connected to and extend upwardly from the temples of the frame. Advantageously, a pair of appendage-engaging novelty items 130 can be connected to the appendages and can be spaced above the temples. The appendage-engaging novelty items can comprise imitation parts 132 of an animal, mammal, human being, bird, fish, insect, avatar or cartoon character. At least part of the novelty items can overhang and extend outwardly and upwardly from the appendages when the eyeglasses are being worn by the person. Preferably, the appendages can having temple-engaging lower base portions 134 (FIG. 12) that are securely connected to and extend upwardly from the temples and can have an outer upper support portions 136 that are securely connected and extend upwardly from the lower base portion to support and receive the novelty items.

The lenses can comprise optical lenses, such as: plastic lenses, glass lenses, tinted lenses, transparent lenses, polarized lenses, photo chromic lenses, sunglass lenses, slit lenses, yellow lenses, amber lenses, grey lenses, brown lenses, black lenses, red lenses, pink lenses, blue lenses, lenses with hues of any of the preceding colors, three-dimensional (3D) lenses, or a combination of any of the preceding.

The frames can comprise: plastic frames, wire frames, metal frames, wooden frames, composite frames, white frames, black frames, colored frames, yellow frames, orange frames, gold frames, brown frames, grey frames, blue frames, pink frames, red frames, frames with hues of any of the preceding colors, rigid frames, semi-rigid frames, flexible frames, resilient frames, or combinations of any of the preceding.

The appendages can comprise: flexible appendages resilient appendages, bendable appendages, elongated appendages, rigid appendages, semi-rigid appendages, complementary appendages, cantilevered appendages, curved appendages, arched appendages, plastic appendages, molded appendages, wire appendages, coiled spring appendages, helical spring appendages, metal appendages, wooden appendages, composite appendages, white appendages, black appendages, colored appendages, yellow appendages, orange appendages, gold appendages, brown appendages, grey appendages, blue appendages, pink appendages, red appendages, appendages with hues of any of the preceding colors, rubber appendages, elastomeric appendages, or combinations of any of the preceding.

The lower base portion of the appendages can comprise: pedestal, stems, bases, threaded base portions, mitered base portions, straight base portions, curved base portions, flat base portions, rounded base portions, rectangular cross-sectional base portions, or combinations of any of the preceding.

The upper support portions of the appendages can be spaced at an elevation above the temples. The upper support portions of the appendages can comprise: curved support portions, arched support portions, converging support portions, diverging support portions, flexible support portions, resilient support portions, symmetrical support portions, complementary support portions, bendable support portions, rigid support portions, semi-rigid support portions, elastomeric support portions, or combinations of any of the preceding.

The novelty items can comprise: plush novelty items, stuffed novelty items, fur novelty items, faux fur novelty items, hairy novelty items, foam novelty items, rubber novelty items, elastomeric novelty items, resilient novelty items, foam novelty items, textile novelty items, cloth novelty items, wool novelty items, plastic novelty items, composite novelty items, wooden novelty items, metal novelty items, metallic foil novelty items, sponge novelty items, inflatable novelty items, detachable novelty items, interchangeable novelty items, symmetrical novelty items, complementary novelty items, water-resistant novelty items, flame-retardant novelty items, or combinations of any of the preceding.

The eyeglass assembly can have at least one image 138 (FIG. 12) on the inside or outside of the eyeglass assembly, the inwardly or outwardly facing surface of a lens, the inwardly or outwardly facing surface of the eyeglass frame, and/or the inwardly or outwardly facing surface of the appendage. The image can comprise: a logo, indicia, symbol, design, trademark, service mark, brand name, company name, black indicia, white indicia, colored indicia, characters, letters, words, text, numbers, alpha numeric image, graphics, flag, hologram, laser etched image, embossed image, imprinted image, stamped image, screen printed image, printed image, anodized image, etched image, lithograph image, decal image, engraved image, and combinations of any of the preceding.

The specialty eyeglasses can have connectors 140 (FIG. 12) to connect the appendages to the novelty items. The connectors can include: thread, yarn, rope, string, wire, and/or pins. The support portions of the appendages can define passageways 142 which extend through the support portions to receive part of the connectors. The passageways can comprise: holes, openings, and/or apertures. At least part of the connectors can pass through the passageways.

The novelty items can comprise support portion-engagers 144 (FIG. 10) to engage and snugly receive the support portions of the appendages. The support-portion engagers can be a tube, socket, and/or pocket.

The imitation parts can be: interchangeable imitation parts, imitation animal parts, imitation mammals parts, imitation human parts, imitation bird parts, imitation fish parts, imitation insect parts, avatar parts, cartoon character parts, imitation ears, imitation antlers, imitation horns, imitation fins, imitation tails, imitation heads, imitation hands, imitation feet, imitation claws, imitation monkey ears, imitation giraffe ears, imitation lion ears, imitation tiger ears, imitation badger ears, imitation bear ears, imitation cub ears, imitation panda ears, imitation wolf ears, imitation dog ears, imitation cat ears, imitation elephant ears, imitation hippopotamus ears, imitation panther ears, imitation alligator heads, imitation crocodile heads, imitation buck antlers, imitation bull horns, imitation cow horns, imitation moose antlers, imitation horse ears, imitation rabbit ears, imitation bunny ears, imitation mouse ears, imitation kangaroo ears, imitation angel wings, imitation bird wings, or combinations of any of the preceding.

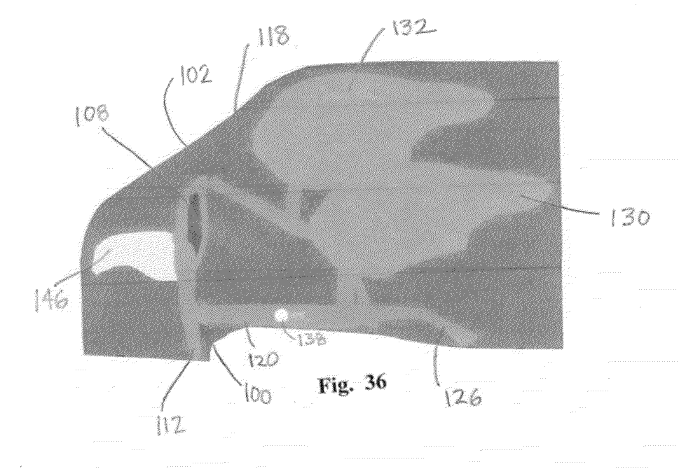

The novel eyeglasses can include at least one supplemental part 146 (FIGS. 3, 9, 35 and 36), such as a: frame engaging imitation part connected to the frame, a novelty item-engaging part connected to the novelty item, imitation animal part, imitation bird part, imitation fish part, imitation mammal part, imitation horse mane, imitation bird beak, imitation bird bill, imitation tusk, imitation nose, imitation sideburns, imitation beard, imitation feet, imitation hoofs, imitation claws, imitation bowtie, imitation talons, imitation tail, imitation fin, and/or combinations of any of the preceding.

The invention is directed to novelty items that can fit upon or be securely or removably connected to the appendages. The novelty items, such as imitation fur ears, can be anchored to the appendage in two ways. First, there can be a tube within the fur ear that the appendage slides into. Second the appendage itself can have two holes that are used to sew the ear to the appendage to anchor the ear after the appendage is slipped into the inner tube. From the outside view, because of the fur, one can't clearly see how the ears are attached to the sunglasses.

Six molds of different appendages can be used. However, more or less molds can also be used.

As examples, imitation parts of animals are described hereinafter for the novelty items and the appendages.
1. Tiger and bear: the appendage can start at the temple side piece and arcs to within two and a half inches from each other. The tiger, bear, etc ears can face forward and appear toward the top of the arc so that they sit on top of a person's head.
2. Huskie or house: the appendage can only go up from the temple two-thirds the way and does not allow the ears to set on top of the head. The ears can sit somewhat on the side of the head like a huskie dog or horse.
3. Wing, bull horn or cow horn: this appendage comes out of the temple and can only go up about three inches where a wing or bull/cow horn would attach.
4. Combo badger or wolverine: this can include the full appendage of the tiger where the badger ears sit on top of the head but a lower appendage can be added that comes out directly below the upper appendage such at a 45 degree angle below the upper appendage such at a 45 degree angle toward the face matching the human jaw line. The fur can be slipped so that the person wearing the sunglasses would have ears on top, fur down the appendage and fur on the lower appendage looking like a badger or wolverine depending on the fur make up.
5. Talons on lower appendage only. On the lower part anything could be attached, e.g. sideburns, bird feet, such as the Atlanta Falcons feet part of their logo, lions, mane beard, etc.
6. Horse mane or shark fin: at the end of the tiger appendage on the top and only one side, a three fingered comb can be applied. This would be used as a platform for anything that would be needed in between the ears such as a horse mane. This can be used for the colts of the broncos. Facing the sunglasses, the left appendage can be the huskie appendage but the right would be the tiger appendage with the three fingered comb attached to the end of the appendage. On the right appendage, there can be no fur between the horse ear and the mane which would be anchored to the flat fingered comb. When the person has the sunglasses on, it can look like they had two horse ears and a mane out of the top of their head. The spread out fingers allow a platform for a mane to sit and rest backward on the head of the wearer. The same could be done with fins and a dorsal fin for all types of fish.
7. Plush imitation animal ears can be placed on the appendages of the sunglasses but the ears can be made of foam or any material. Foam can be used for Tinkerbelle elf ears. Elf ears are basically the wing design except the elf ears have a long back so that any child's ear could slip between the front and back space and look like an elf without having to fit the ear size.

Among the many advantages of the improved eyeglasses and novelty shades are:
1. Superior product design which can be worn at sporting events, pep rallies, amusement parks, popular concerts, car races, parties, and with costumes, such as at Halloween or Marti Gras.
2. Outstanding performance.
3. Fashionable.
4. Entertaining.
5. Safe.
6. User friendly.
7. Reliable.
8. Readily transportable.
9. Light weight.
10. Portable.
11. Comfortable.
12. Easy to use and wear.
13. Simple to manufacture.
14. Durable
15. Economical.
16. Attractive.
17. Fun.
18. Compact.
19. Efficient.
20. Effective.

Although embodiments and examples of the invention have been shown and described, it is to be understood that various modifications, substitutions, and rearrangements of parts, components, and/or process (method) steps, as well as other uses, shapes, construction, and design of the improved eyeglasses and novelty shades can be made by those skilled in the art without departing from the novel spirit and scope of this invention.

What is claimed is:

1: Eyeglasses, comprising:
an eye glass assembly including
a frame;
at least one appendage connected to said frame; and
a novelty connected to said appendage.

2: Eyeglasses in accordance with clam 1 wherein:
said frame is of a size and shape so that the eyeglasses can be worn by a wearer comprising a person selected from the group consisting of a child or adult; and
at least part of said novelty is positioned at an elevation above an ear of the person when the person is wearing the eyeglasses.

3: Eyeglasses in accordance with clam 2 wherein said appendage comprises an upward appendage for extending upwardly from the frame when the person is wearing the eyeglasses.

4: Eyeglasses in accordance with clam 1 wherein said eyeglasses are selected from the group consisting of: sunglasses, novelty sunglasses, fanciful shades, three dimensional (3D) glasses, eyewear, fashion eyeglasses, designer sunglasses, and specialty eyeglasses.

5: Eyeglasses in accordance with clam 1 including a logo or other image on the eyeglass assembly.

6: Eyeglasses in accordance with clam 1 wherein said novelty has a pocket or tube for receiving and engaging said appendage.

7: Eyeglasses in accordance with clam 1 wherein:
said appendage comprises a base portion connected to said frame; and
an outer portion connected to said base portion for engaging and supporting said novelty.

8: Eyeglasses in accordance with clam 1 wherein said novelty is selected from the group consisting of: a novelty item, appendage-engaging member, accessory, decoration, adornment, ornament, attachment, and combinations thereof.

9: Eyeglasses comprising:
an eyeglass assembly including
lenses;
a frame holding said lenses and having temples with ear pieces that fit upon the ears of a user when the eyeglasses are being worn by the user;
upward appendages connected to and extending upwardly from said temples; and
novelty items connected to said appendages and comprising imitation parts of an animal, mammal, human being, bird, fish, insect, avatar, or cartoon character; and
at least part of said novelty items extend outwardly and upwardly from said appendages when the eyeglasses are being worn by the user.

10: Eyeglasses in accordance with clam 9 wherein said imitation parts are selected from the group consisting of: ears, antlers, horns, fins, tails, heads, hands, feet, talon, claws, and wings.

11: Eyeglasses in accordance with claim 9 wherein said novelty items comprise interchangeable novelty items.

12: Eyeglasses in accordance with claim 9 wherein said novelty items are spaced above said temples.

13: Eyeglasses in accordance with claim 9 including a logo or other image on the eyeglass assembly.

14: Eyeglasses comprising:
an eyeglass assembly having an inside comprising inwardly facing surfaces and an outside comprising outwardly facing surfaces, said eyeglass assembly including;
a pair of lenses for positioning in front of a person's eyes;
an eyeglass frame having rims for holding and securing said lenses, a bridge extending between and connecting said rim, nose pads connected to said rims for resting upon and positioning the frame on the person's nose, a pair of elongated temples pivotally hinged and connected to said rims, said temples having earpieces that fit upon the person's ears, said temples being moveable from a collapsed storage position against the inward facing surfaces of the rims to an open expanded position when the person is wearing the eyeglasses;
a pair of substantially symmetrical upward appendages securely connected to and extending upwardly from said temples;
appendage-engaging novelty items connected to said appendages and spaced above said temples, said appendage-engaging novelty items comprising imitation parts of an animal, mammal, human being, bird, fish, insect, avatar or cartoon character, and at least part of said novelty items overhanging and extending outwardly and upwardly from said appendages when the eyeglasses are being worn by the person; and
said appendages having temple-engaging lower base portions securely connected to and extending upwardly from said temples and having outer upper support portions securely connected to and extending upwardly from said lower base portion for supporting and receiving said novelty items.

15: Eyeglasses in accordance with claim 14 wherein:
said lenses comprise optical lenses selected from the group consisting of plastic lenses, glass lenses, tinted lenses, transparent lenses, polarized lenses, photo chromic lenses, sunglass lenses, slit lenses, yellow lenses, amber lenses, grey lenses, brown lenses, black lenses, red lenses, pink lenses, blue lenses, lenses with hues of any of the preceding colors, three-dimensional (3D) lenses, and combination of any of the preceding;
said frames are selected from the group consisting of plastic frames, wire frames, metal frames, wooden frames, composite frames, white frames, black frames, colored frames, yellow frames, orange frames, gold frames, brown frames, grey frames, blue frames, pink frames, red frames, frames with hues of any of the preceding colors, rigid frames, semi-rigid frames, flexible frames, resilient frames, and combinations of any of the preceding;
said appendages are selected from the group consisting of flexible appendages resilient appendages, bendable appendages, elongated appendages, rigid appendages, semi-rigid appendages, complementary appendages, cantilevered appendages, curved appendages, arched appendages, plastic appendages, molded appendages, wire appendages, coiled spring appendages, helical spring appendages, metal appendages, wooden appendages, composite appendages, white appendages, black appendages, colored appendages, yellow appendages, orange appendages, gold appendages, brown appendages, grey appendages, blue appendages, pink appendages, red appendages, appendages with hues of any of the preceding colors, rubber appendages, elastomeric appendages, and combinations of any of the preceding:
said lower base portion of said appendages are selected from the group consisting of pedestal, stems, bases, threaded base portions, mitered base portions, straight base portions, curved base portions, flat base portions, rounded base portions, rectangular cross-sectional base portions, and combinations of the preceding;
said upper support portions of said appendages are spaced at an elevation above said temples and are selected from the group consisting of curved support portions, arched support portions, converging support portions, diverging support portions, flexible support portions, resilient support portions, symmetrical support portions, complementary support portions, bendable support portions, rigid support portions, semi-rigid support portions, elastomeric support portions, and combinations of any of the preceding; and
said novelty items are selected from the group consisting of plush novelty items, stuffed novelty items, fur novelty items, hairy novelty items, foam novelty items, rubber novelty items, elastomeric novelty items, resilient novelty items, foam novelty items, textile novelty items, cloth novelty items, wool novelty items, plastic novelty items, composite novelty items, wooden novelty items, metal novelty items, sponge novelty items, inflatable novelty items, detachable novelty items, interchangeable novelty items, symmetrical novelty items, complementary novelty items, water-resistant novelty items, flame-retardant novelty items, and combination of any of the preceding.

16: Eyeglasses in accordance with claim 14 including:
at least one image on said eyeglass assembly;
said image being at a location selected from the group consisting of the inside of the eyeglass assembly, the outside of the eyeglass assembly, an inwardly facing surface of a lens, an outwardly facing surface of said lens, an inwardly facing surface of said eyeglass frame, an outwardly facing surface of said eyeglass frame; an inwardly facing surface of said appendage and an outwardly facing surface of said appendage;
said image being selected from the group consisting of a logo, indicia, symbol, design, trademark, service mark, brand name, company name, black indicia, white indicia, colored indicia, characters, letters, words, text, numbers, alpha numeric image, graphics, flag, hologram, laser etched image, embossed image, imprinted image, stamped image, screen printed image, printed image, anodized image, etched image, lithograph image, decal image, engraved image, and combinations of any of the preceding.

17: Eyeglasses in accordance with claim 14 including:
connectors for connecting said appendages to said novelty items, said connectors are selected from the group consisting of thread, yarn, rope, string, wire, and pins;
said support portions of said appendages define passageways extending through said support portions for receiving part of said connectors;
said passageways are selected from the group consisting of holes, openings, and apertures; and
at least part of said connectors pass through said passageways.

18: Eyeglasses in accordance with claim 14 wherein:
said novelty items comprise support portion-engagers for engaging and snugly receiving said support portions of said appendages; and
said support-portion engagers are selected from the group consisting of a tube, socket, and pocket.

19: Eyeglasses in accordance with clam 14 wherein said imitation parts are selected from the group consisting of: interchangeable imitation parts, imitation animal parts, imitation mammals parts, imitation human parts, imitation bird parts, imitation fish parts, imitation insect parts, avatar parts, cartoon character parts, imitation ears, imitation antlers, imitation horns, imitation fins, imitation tails, imitation heads, imitation hands, imitation feet, imitation claws, imitation monkey ears, imitation giraffe ears, imitation lion ears, imitation tiger ears, imitation badger ears, imitation bear ears, imitation cub ears, imitation panda ears, imitation wolf ears, imitation dog ears, imitation cat ears, imitation elephant ears, imitation hippopotamus ears, imitation panther ears, imitation alligator heads, imitation crocodile heads, imitation buck antlers, imitation bull horns, imitation cow horns, imitation moose antlers, imitation horse ears, imitation rabbit ears, imitation bunny ears, imitation mouse ears, imitation kangaroo ears, imitation angel wings, imitation bird wings, and combinations of any of the preceding.

20: Eyeglasses in accordance with clam 19 including at least one supplemental part selected from the group consisting of a frame engaging imitation part connected to said frame, a novelty item-engaging part connected to said novelty item, imitation animal part, imitation bird part, imitation fish part, imitation mammal part, imitation horse mane, imitation bird beak, imitation bird bill, imitation tusk, imitation nose, imitation sideburns, imitation beard, imitation feet, imitation hoofs, imitation claws, imitation bowtie, imitation talons, imitation tail, imitation fin, and combinations thereof.
